(19) United States
(12) Patent Application Publication
(10) Pub. No.: US 2014/0313072 A1
(43) Pub. Date: Oct. 23, 2014

(54) ICE KEEL PREDICTION FROM SAR, OPTICAL IMAGERY AND UPWARD LOOKING SONARS

(71) Applicant: CONOCOPHILLIPS COMPANY, Houston, TX (US)

(72) Inventors: Khalid A. SOOFI, Katy, TX (US); John R. COLOGGI, Eagle River, AK (US); Dominique P. BERTA, Flower Mound, TX (US); Peter G. NOBLE, Spring, TX (US); Christopher M. YETSKO, Richmond, TX (US)

(73) Assignee: CONOCOPHILLIPS COMPANY, Houston, TX (US)

(21) Appl. No.: 14/257,440

(22) Filed: Apr. 21, 2014

Related U.S. Application Data
(60) Provisional application No. 61/815,077, filed on Apr. 23, 2013.

(51) Int. Cl. G01S 13/90

(52) U.S. Cl. CPC G01S 13/90
USPC 342/25 A

(57) ABSTRACT

A method correlates satellite image data with data taken from multiple upward-looking sonars moored on the sea floor. The correlation of this information facilitates the prediction of ice thickness in later seasons using synthetic aperture radiation only, thus allowing for the assessment of threats to oil exploration, production or completion facilities located in the Arctic Ocean.

### CROSS-REFERENCE TO RELATED APPLICATIONS

This application is a non-provisional application which claims benefit under 35 USC §119(e) to U.S. Provisional Application Ser. No. 61/815,077 filed Apr. 23, 2013, entitled “ICE KEEL PREDICTION FROM SAR, OPTICAL IMAGERY AND UPWARD LOOKING SONARS,” which is incorporated herein in its entirety.

### STATEMENT FEDERALLY SPONSORED RESEARCH OR DEVELOPMENT

Not Applicable

### REFERENCE TO MICROFICHE APPENDIX

Not applicable.

### FIELD OF THE INVENTION

This invention relates generally to simultaneous measurements of ice movement and keel thickness, and particularly to a method of correlating ice thickness as determined by upward looking sonars with synthetic aperture radar (“SAR”) images for future real-time ice thickness predictions using only SAR.

### BACKGROUND OF THE INVENTION

Due to increasing need of oil and field depletion, finding new hydrocarbon reservoirs and resources has become paramount. Most areas of the world have been scoured looking for new discoveries. Few expect that any large, undiscovered resources remain to be found near populated areas and in places that can be easily accessed. Instead, new large reserves are being found in more challenging and difficult to reach areas, such as subsea locations or the Arctic. The ocean floor inside the Arctic Circle alone may hold up to a quarter of the Earth's yet undiscovered oil.

Even though wells have been drilled in the Arctic since the 1980s, it is still one of the great, untapped frontiers because of the hostile weather, freezing conditions, and remote location. In 2009, the United States Geological Survey estimated that the entire Arctic has about 90 billion barrels of recoverable oil, 1.669 trillion cubic feet of natural gas, and 44 billion barrels of natural gas liquids. Energy experts believe the Arctic Seas could produce up to a million barrels of oil a day.

However, prospecting, drilling and completion of oil wells in the Arctic is daunting. The window for drilling in the Arctic is limited by ice floes and climatic conditions. In the winter, landfast ice, or ice that has frozen along the coast or the sea floor, forms quickly, making many regions inaccessible. Even in the summer months, gale force winds are able to move giant ice floes, thus forcing ships to constantly readjust their positions. Moving ice can damage equipment and increases the risk of hydrocarbon spills.

Information regarding ice keel thickness and ice movement is important for developing better approaches to offshore oil work in the Arctic and preventing hydrocarbon leaks. Offshore operators in the Arctic rely on subsea pipelines to manage and transport hydrocarbons, thus avoiding surface floes. However, these pipelines are still at risk of being gorged by ice keels. The gouging generally occurs when keels drift into shallow waters, where most Arctic drilling occurs, and are still thick enough to plow into the seafloor. Thus, keel thickness and movement influence pipeline design, route selection, and burial of the pipeline. Ice floes can also damage drillships, oil rigs, and wells.

While there have been Arctic specific design improvements in many oil rigs (see e.g. ice-worthy jack-ups, US20120128426), the risk of damage is not completely removed. Furthermore, drilling rigs must be shut down when there is a threat of hazardous ice floes.

Thus, understanding and predicting ice keel thickness and ice movement is important as a means of assessing threats to oil facilities and as a means for facilitating informed ice management threat mitigation processes to prevent damage to sites and reduce the risk of hydrocarbon leaks.

Currently, ice thickness is determined by either coring ice ridges or by utilizing upward looking sonars moored on the sea floor, on autonomous unmanned vehicles, or on submarines. Coring is impractical because accurate data would require holes being drilled every couple of feet. Collecting data using a submarine is also not practical, because most wells are drilled in shallow areas inaccessible by submarines. Upward-looking sonar (ULS) devices that are anchored on the sea floor are commercially available for determining this thickness of ice for pipeline installations and examining the underside of the ice; however, these devices are in a fixed location with limited viewing area and data is usually not accessible in real time.

Furthermore, the oil industry needs to know how ice moves on a near continuous basis. In the Arctic, ice is usually composed of ‘floes,’ which are large bodies of ice that may extend up to several hundred square miles and move in erratic ways. It should also be noted that different types of ice exist and can wreak havoc in different ways, thus requiring an ability to differentiate between the types. For instance, icebergs are isolated ice that can move freely and is stronger than sea ice. Whereas sea ice, especially first-year ridges, is surrounded by an ice sheet and have keels that are thought to be much weaker.

Geospatial imagery provides specific information about geographic areas of interest, thus satellite imaging is currently used to monitor ice floes on a near continuous basis and may even differentiate between the different types of ice.

Much has been done to track and predict Arctic ice movement. U.S. Pat. No. 5,122,990 discloses a method for using a downward-looking acoustic sonar system attached to a moving vessel to profile water currents and could be used for tracking the movement of sheets of ice. US20110291862 discloses an integrated warning system to alert drilling platforms of pending hazards using multiple data sources for detecting and characterizing ice floe movement including satellite imagery, unmanned underwater vehicles, and remote operated vehicles on a near continuous basis. However, neither suggest a method of estimating the ice thickness.

U.S. Pat. No. 4,697,254 discloses a method of measuring ice floe thickness using a submarine equipped with a sonar. U.S. Pat. No. 7,095,359 discloses a method of observing the ice draft using an ice thickness measurement sonar moored on the sea floor, a current meter moored on the sea floor, buoys and the backscattering coefficients of a high resolution airborne synthetic aperture radar (SAR). A relational expression between the actual measurements of ice thickness obtained by the sonar for a previous year and data obtained by the SAR backscattering coefficient profile was calculated, then used to determine the ice draft (ice thickness below the waterline). However, the rational expression was limited by the SAR measurements because SAR backscattering observations were only available at limited intervals. This led to a weak correlation because certain backscattering coefficients could only detect ice thickness of approximately 10 cm. Furthermore, little information about how large the ice was or its directional movement was obtained from the SAR imagery.

The art is lacking an accurate, near-real time method of observing ice movement and ice thickness data. Since both sets of information are necessary to provide a complete picture for assessing the ice threat to the oil industry, what is also needed in the art is a method of correlating ice thickness data with ice movement data to facilitate prediction of ice movement and character. Also, what is needed in the art is a cost-effective method of estimating the thickness of the ice floe in real time without waiting until the summer months to retrieve data from a ULS.

### SUMMARY OF THE INVENTION

The present invention is a method of making ice keel predictions using Synthetic Aperture Radar (SAR), optical imagery and upward looking sonars (ULS). Generally, the present invention correlates ice keel thickness measured by ULS during the previous winter season with satellite images of ice. The relational expression can then be used to estimate ice thickness in the future using SAR only. This allows for the use of SAR and optical imagery to track the movement of ice near drilling equipment and to estimate the ice thickness in near-real time, thus allowing for evasive action to be taken when necessary.

Once the ice melts in the summer, data from the ULS can be used to determine the accuracy of the SAR-only thickness predictions of the previous winter. This allows for the correlation to be refined over the course of multiple years to provide a more accurate relational expression.

The benefit of such a correlation is the ability to construct near-real time ice movement forecasts and ice keel thickness to help access the threat to oil facilities, and to facilitate informed ice management threat mitigation processes. The present invention is expected to help the oil industry explore and recover hydrocarbons from oil reserves in the Arctic and reduce the risks of accidents and leaks.

Ice thickness can also be determined using the Radar Backscattering Cross-Section (RCS), or scattering coefficient, derived from SAR imagery. There is sparse work correlating RCS pixels with sea ice thickness, but RCS has been used to classify sea ice thickness in ‘buckets’ where each bucket has a thickness range for each ice year (i.e. first year ice is 0.8-1.2 meters, second year ice is 1.2-4 meters and multiyear ice is >4 meters). However, the presence of snow on top of the ice is known to distort the RCS values. As such, the sea ice thickness data from SAR imagery has not found much use in the oil and gas industry.

However, if enough snow-free SAR images are taken to establish a statistically valid correlation with the ULS data, then the relational expression can be applied to future satellite images to estimate the ice thickness in real time.

In the present invention, ice direction, ice thickness and ice velocity can be measured at a ULS site. Upward-looking sonars are already known and commercially available, thus one skilled in the art would be able to select an ULS that complement their needs. A typical ULS site employs both single-beam ice profiling units and multiple-beam current profiling units. The ice profiling units provides information about the ice keel thickness, the distribution of frazil and other phenomena under ice, whereas the current profiling units provides water current and ice velocity data. The ice thickness time series data from the profiling unit and the ice draft distance series data from the current profiling unit are combined to provide an accurate profile of the underside ice topography and movement.

ASL Environmental Sciences has a commercially available Ice Profiling Sonar (ISP) specifically for mooring on the sea floor and a Shallow Water IPS for locations adjacent to shorelines. Acoustic Doppler Current Profilers (ADCP) are also available from ASL. Nortek offers an ‘AWAC DCP.’

In one embodiment, the ice profiling unit and the current profiling unit are attached inline to the same anchor. In another embodiment, they are anchored adjacent to each other.

Standard sea floor anchoring technology can be used. Because of the ice coverage, submerged buoys are typical used. FIG. 2A displays exemplary mooring configurations using submerged buoys. Here, the mooring has an acoustic release 14 that connects the mooring to an anchor weight 15 on the sea floor, and, upon the acoustic command signal, the weight is released and left on the sea floor while the buoys 12 lift the ice profiling unit 11 and the current profiling unit 13 to the water surface. Other options include the use of a submersible platform, similar to the one in EP2184974, with the ULS units attached.

In yet another embodiment, the ice profiling unit and the current profiling unit are mounted onto the sea floor, using e.g. concrete stand. Piles and cans may also be used.

Due to the inaccessibility of the Arctic Ocean and cost of deployment, ULS units have already been positioned by various agencies. For instance, oil industry operators have in place a data sharing agreement for four sonar measurement sites in the Chukchi Sea.

FIG. 3 shows all the moored ASL Upward Looking Ice Profiler Sonars () in the Chukchi Sea as of 2009 as part of a collaborative undertaking by the Canadian Institute of Ocean Science, USA Cold Regions Research Engineering Laboratory and the NOAA Arctic Research Office. Data collected at these moorings are available for use by the broad scientific community.

Thus, data can be obtained from pre-positioned ULS if the location of the ULS accurately captures the area of interest. Because ULS data for an entire winter season is necessary for the correlation, both real-time and delayed ULS data acquisition can be used.

In one embodiment of the present invention, a single ULS site is used to collect data for correlating with satellite imagery. However, depending on the size and location of oil and gas equipment, multiple ULSs sites may be necessary to collect data adjacent to the equipment and in the perimeter to allow time for threat mitigation. Thus, another embodiment of the present invention uses multiple ULS sites to gather ice character data.

In one embodiment, a plurality of ULS sites are moored in a concentric fashion around a drilling rig, to allow early warning of hazardous ice floes. In another embodiment, the ULS sites are moored along a preselected boundary some distance from the oil and gas equipment.

The present invention can also be used with continuous, real-time ULS data. In this case, real-time SAR and optical images will be assigned a thickness without the use of the relational expression. Such a method utilizing continuous real-time ULS data would require a cable connecting the ULS to land or a drilling rig because wireless communication is not very reliable under arctic conditions. However, moving ice floes and severe weather can damage these cables. Thus, while it is possible to use real-time ULS data, this method may not be preferred at this time.

The two types of satellite imaging techniques being used in the present invention are SAR and optical imagery. SAR and optical imagery are considered to be complementary types of imagery. Optical imagery produces a photo-like image of a given area (see FIG. 3), but is limited by light and weather conditions. However, SAR is capable of recording data at all times of day and in all weather conditions and provides information about 3D structure and moisture content. SAR images are almost topological in that many features of ice are discernible, even in low-resolution images. FIG. 4 is a low-resolution SAR that shows multi-year ice 30 as a bright area, first-year ice 31 as a dark grey area, and leads (areas where ice has previously moved apart to expose open water, which quickly forms new ice) 32 as long, linear dark features. Together, these techniques will provide information regarding the movement and size of ice.

The SAR and optical imagery equipment used for the present invention can be any known in the art or to be developed that is capable of taking stereo images. Stereo images consist of two images of the same area acquired with different incidence angles. The stereo imagery allows seeing where the ice has ridges or stacked sheets of ice without ambiguity. An additional benefit of stereo images is the ability to use the back up image as relief data in case the initial image is not usable. This is especially important for optical images.

Additionally, while the present invention described below uses equipment located on satellites that orbit the earth, images can also be obtained from equipment on non-orbiting objects, such as airplanes or flying balloons.

U.S. Pat. No. 7,095,359 used previously used SAR imagery to monitor ice. However, the ability to collect images were very limited. For instance, U.S. Pat. No. 7,095,359 collected SAR images at 20-hour intervals. Such a large interval between images prevents real-time assessments and slows the ability to take evasive actions. Furthermore, the thickness estimations in U.S. Pat. No. 7,095,359 required multiple correlations using various X and L-bands, thus slowing near real-time assessments.

As such, the present invention takes advantage of the current satellite technology. Today, there are more satellites available and these satellites are better at collecting images. As such, there exist a constellation of satellites capable of collecting SAR and optical images of the sea ice every 4-5 hours per day, and the interval continues to decrease as more satellites are deployed. This produces enough images to show ice movement in closer to real time, thus allowing time to prepare and take evasive actions.

For SAR, any frequency range can be used, with the 1 to 40 GHz being preferred, and the 8 to 12 GHz (“X-Band”) being most preferred.

The TerraSAR-X High Resolution Satellite is one preferred source of SAR data because the X-band of the satellite is optimally suited to differentiating between various types of ice, is capable of taking stereo images, and has a resolution as high as 1 m. However, imagery from its twin satellite, TanDEM-X, can also be utilized. Lower resolution SAR aboard RADARSTAT-1, Nimbus-7 and ENVISAT are also available for use.

The COSMO-SkyMed constellation of four VHR SAR satellites, owned by the Italian Space Agency (ISA), is another system that may be particularly useful. The first satellite used an X-band radar; later satellites were equipped with more sophisticated multi-mode X-, C- L- and P-band instruments. The constellation and associated ground segment provide global, all-weather, day-night surveillance coverage of the earth's surface. Stereo imaging is possible in a single pass, and ground track repeatability is better than 1 km. The COSMO-SkyMed satellites have several imaging modes, including:
Spotlight/Frame: Spot observation area: 10 km×10 km, resolution under 1 m
HIMAGE/Stripmap: Swath width: 40 km, resolution 3-15 m
WideRegion/ScanSAR: Swath width: 100 km, resolution 30 m
HugeRegion/ScanSAR: Swath width: 200 km, resolution 100 m
Ping Pong/Stripmap: Swath width: 30 km, resolution: 15 m

Many optical imaging satellite systems are used to image the Arctic. The SPOT (Systeme Pour l'Observation de la Terre aka “System for Earth Observation’) high-resolution optical imaging satellite system is the preferred source of optical data because it is capable of taking stereo pair images with 1.5 m resolution as of SPOT 6 (launched September 2012). Lower resolution images, such as those from the Landsat-5, QuickBird, KOMPSAT-2, OrbView-3 or IRS Liss III, can also be utilized.

The stereo imagery for the SAR and optical imagery allows identifying various ice features without ambiguity. Furthermore, relative size and movement of the ice can be determined from the SAR and optical imagery. This information may also influence the evasive methods taken by rigs.

After correlating the ULS data with the SAR data, the relational expression is be applied to future obtained SAR images to estimate the ice thickness, even when ULS is not available in real time. The isostasy method forms the basis on this estimation. The isostasy method is used to derive the maximum, minimum, average (or all) keel depth from the amount of ice sticking above the water baseline.

Typically, water leads are used to establish the baseline of the water level. This is often problematic for areas with solid ice coverage. However, even in hard winter months, there should be enough leads in the area of interest to establish the baseline.

When ice is moving quickly, the SAR imagery may not be capable of obtaining enough data for a suitable correlation. In these cases, additional airborne SAR, or even, LIDAR data can be used to extract relief data.

The present invention is expected to benefit the oil industry located in the Arctic. However, almost any industry or association needing a near-real time measurement of ice movement and thickness, such as academic researchers, environmental groups, or commercial fishermen, will benefit from the present invention.

The term “sea ice” means frozen sea water and includes floating ice floes, fast ice, drift ice, and may on occasion include icebergs (frozen fresh water).

The term “upward-looking sonar” refers to sonars located below the ice and pointed such that the sound propagation is directed towards the underside of the ice. Such sonars can be moored to the sea floor or attached to submerged vessels such as a submarine or unmanned vehicle. Each ULS site in the present invention involves an ice profiling sonar and a Doppler current profiling sonar moored to the sea floor.

The term “satellite” as used herein refers to an object that has been placed into orbit around the earth by human endeavor.

The term “satellite imagery” as used herein refers to imaging techniques, such as radar or optical, located on moving, airborne objects. These airborne objects are not limited by altitude. Rather, the imaging technique's capabilities limit the altitude of the airborne objects.

The terms “SAR imagery,” “backscattering cross-section,” “scattering coefficient,” and “backscattering profile” are used interchangeably herein to mean the data segment of the returned radar signal after it has been scattered on the surface of the targeted area, where this data segment is typically represented as a topographical-like image of said targeted area. Analysis of the backscattering profile enables estimations of moisture content and surface roughness of the targeted area. Typically, smooth or high moisture content has a darker pixel shade due to the weak backscattering of the radar signal and rough or low moisture content has a lighter pixel shade due to strong backscattering.

The term “ice feature” refers to distinctive parts of sea ice, typically formed by the ice melting, freezing, or colliding with other ice sheets. Commonly observed features include ridges, sails, hummocks, leads, and bergs.

The term “ridge” as used herein refers to a feature of ice where several ice sheets have stacked on top of each other. Ridges are classified by age. Ice sheets often melt during the summer months, but that is not always the case. Thus, first-year ice refers to new ice, second-year ice refers to ice in its second winter season, and multiyear ice refers to ice formed more than two winters ago.

The term “leads” as used herein refers to a feature of ice that is a region of open water formed by the motion of the ice. During winter months, the open water remains in the leads for a short period of time before refreezing.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| | |
|---|---|
| ADCP | Acoustic Doppler Current Profiler |
| IPS | Ice profiling sonar |
| RCS | Radar backscatter cross-section |
| SAR | Synthetic aperture radar |
| ULS | Upward-looking sonar |

### BRIEF DESCRIPTION OF THE DRAWINGS

FIG. 1 displays an exemplary mooring configurations for ULS units.

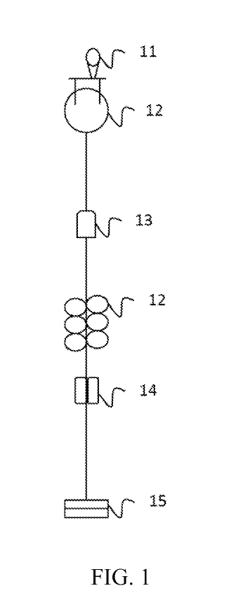

FIG. 2 displays the location of moored ULS in the Chukchi Sea.

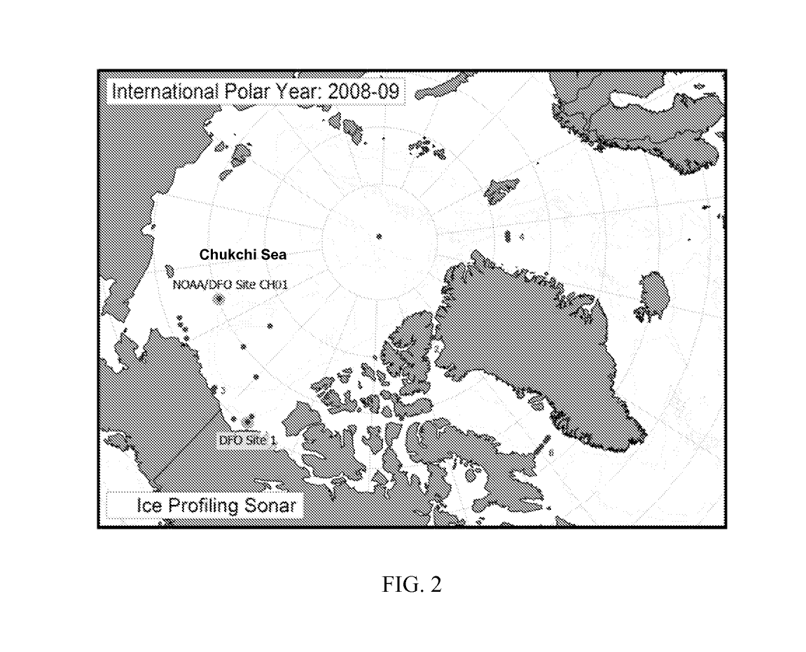

FIG. 3 is an optical image taken Apr. 22, 2004 of the Barents Sea.

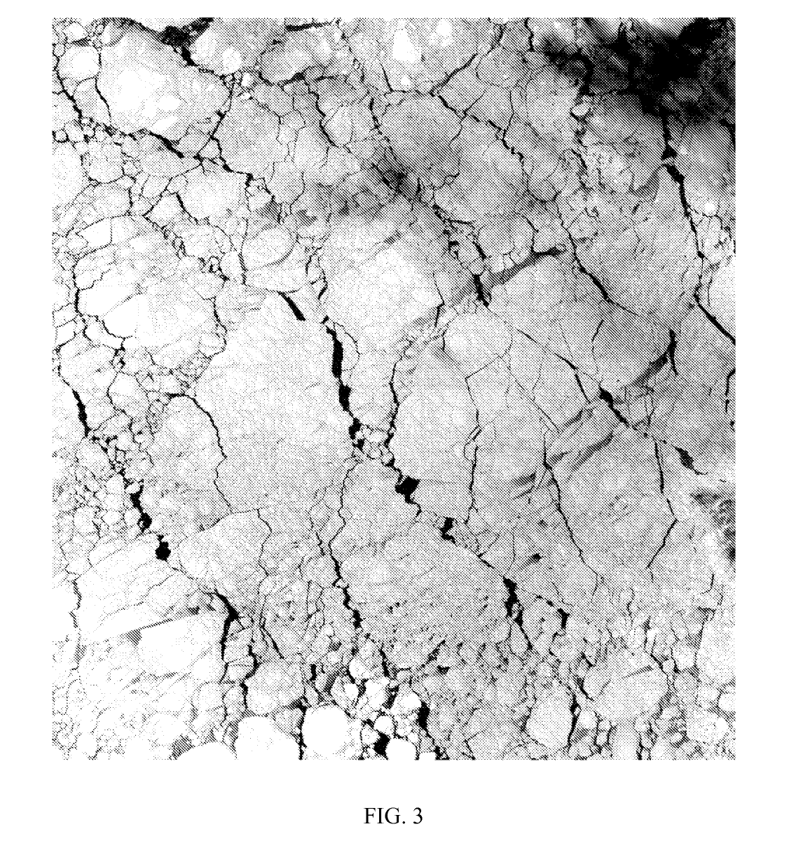

FIG. 4 is an exemplary low-resolution SAR of Beaufort Sea taken by ERS-1 in the winter of 1992 that clearly shows multiple ice features including multi-year ice, first-year ice, and leads.

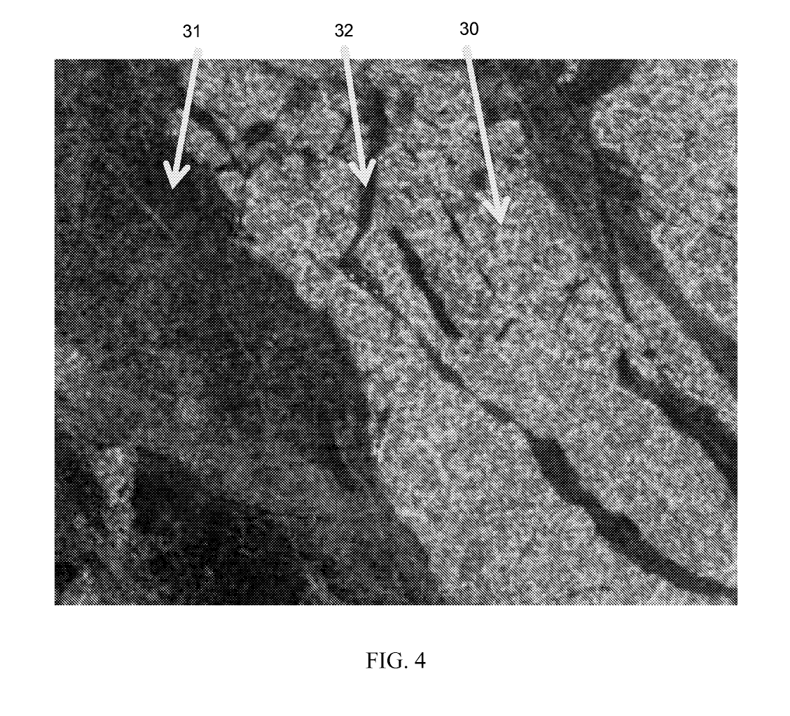

FIG. 5 displays a satellite image taken with TerraSAR-X High Resolution with an expanded excerpt displaying the track line generated by the ‘movie’ of the ULS data.

FIG. 6 displays a composite satellite image of all images taken Winter 2008-09 with the TerraSAR-X High Resolution that has a track line 60 illustrating predicted ice movement over the ULS at Site I.

### DESCRIPTION OF EMBODIMENTS OF THE INVENTION

The present invention provides a novel method of correlating ice thickness data obtained for an upward-looking sonar moored on the sea floor and ice movement data from SAR and optical imagery to track sea ice depth and movement during the season. The information can then be used to predict ice movement and its depth over areas that threaten the oil industry, e.g. drillships, rigs and subsea equipment using SAR. This ice movement forecasting essentially provides a means of assessing the threat to oil facilities and facilitates an informed ice management threat mitigation process.

The following is a detailed description of the preferred method of the present invention. It should be understood that the inventive features and concepts may be manifested in other arrangements and that the scope of the invention is not limited to the embodiments described or illustrated. The scope of the invention is intended to only be limited by the scope of the claims that follow.

For one embodiment, the basic procedure for correlating the ice movement with the ice thickness is as follows:

choosing a data acquisition time span for a plurality of upward-looking sonar sites that track the direction, velocity and thickness of ice and acquiring data over some time period including a complete winter season;

making a ‘movie’ of images acquired during the same time span and period to develop a track line for each sonar site regarding the movements of selected ice features over the sonar unit for some period of time;

overlaying the track lines with SAR images for the whole season; and

correlating the ice thickness with the SAR pixel shading along the track line.

Once correlated, the pixel shading of future acquired SAR images is used to estimate the ice thickness along with the normal ice movement information.

It is unclear what time span for image acquisition may be required to track the ice movement in any particular situation and the time span may depend on the specific circumstances of the location of the sonar and climatic conditions. Typically, ice floes are slow moving (˜0.23 mph), or in the case of packed ice, may not make detectable movements. At a minimum, a 36-hour time span should be used. The time period can be relaxed depending on climatic conditions.

To make a movie, the last image of the ice season is stepped (geographically) back (backward pass') to the time of the previous image using the sonar derived ice direction and velocity data. Likewise, this previous image is stepped forward in time (forward pass'). These two ‘passes’ are compared and interpolation-type corrections are applied to develop a best-guess ‘movie’ of how the ice in the previous image moved over the time frame between images. This process is repeated for all optical image pairs acquired during a particular winter season.

Once the ice movement imagery is processed, it can be used to identify the notable topographical ice features, such as ridges, of the last image as they passed over the ULS sites. This allows for an hour-by-hour assessment of the feature location(s) and allows for the use of the ULS data to tag the images with keel depth/width measurements.

In practice, each image is stepped back as the previous image is stepped forward. As all of the images for a given ice season are processed, the end product is a ‘movie’ that accurately shows how the ice has moved in as fine a time step as chosen. The ‘movie’ provides a track line of how a particular ice feature(s) moves for each ULS unit complete with information regarding ice thickness along the track line. The track line for each sonar unit can be overlaid on the satellite images for the whole season. Furthermore, a graphic displaying the measured ice thickness along this track line can be superimposed on the satellite images. The end result is a visual depiction (from satellite imagery) of the thickness blips at each ice feature over the entire season as they pass over the ULS.

Due to the unpredictable climate conditions, there may be instances where the optical and SAR imagery obtained do not produce usable data for the correlation. The method however, allows for breaks in data acquisition. As such, relief data from other airborne objects can be used to supplement the SAR and optical data. Also, topographical images acquired by Light Detection and Ranging (LIDAR) can be used, however, this is a more costly data acquisition.

### EXAMPLE

Tables 1 and 2 display ice draft measurements taken for Site I during Winter 2008-09 and 2009-10, respectively.

TABLE 1
Winter 2008-09 (Lat: 70°59.972N; Lon: 165°0.073W)

| Date/Time | Max Draft (m) | Mean Draft (m) |
|---|---|---|
| 4/30 11:02 | 26.42 | 16.09 |
| 5/8 13:26 | 26.18 | 14.45 |
| 5/11 2:11 | 25.83 | 15.73 |
| 4/30 22:58 | 24.84 | 16.89 |
| 5/12 0:46 | 24.71 | 18.29 |
| 6/30 5:05 | 23.66 | 14.97 |
| 4/1 13:49 | 22.99 | 15.91 |
| 5/10 14:42 | 22.71 | 13.67 |
| 6/25 1:04 | 22.63 | 15.61 |
| 5/15 1:34 | 21.99 | 13.04 |

TABLE 2
Winter 2009-10 (Lat: 70°59.9510N; Lon: 165°0.134W)

| Date/Time | Max Draft (m) | Mean Draft (m) |
|---|---|---|
| 3/12 2:14 | 26.67 | 15.18 |
| 4/22 13:22 | 26.25 | 18.89 |
| 5/10 10:32 | 25.18 | 16.62 |
| 3/6 17:26 | 24.06 | 17.11 |
| 5/5 15:33 | 23.7 | 18.22 |
| 6/1 8:41 | 22.51 | 12.09 |
| 4/22 14:03 | 22.47 | 15.04 |
| 3/6 9:17 | 22.17 | 14.79 |
| 3/16 22:26 | 21.67 | 13.66 |
| 4/29 4:06 | 21.51 | 15.25 |

Processing ULS Data: Measurements were collected every 12 hrs from Sep. 9, 2008 until Aug. 28, 2009 by an Ice Profiling Sonar (IPS) ULS and ADCP moored at Site I, located at Lat: 70°59.972N; Lon: 165°0.073W. The data was processed using the Ice Profiling Sonar Processing Toolbox for Matlab, which is provided by the ULS manufacturer.

The IPS provides the maximum keel thickness (‘Max Draft’) for its propagation area as well as the mean keel thickness. Stresses in the ice flow may create different ridging and rafting patterns that may make the ice thicker or thinner in different areas. Pressure ridging, shear ridging, and fracturing may influence the ice formation and change the rheology of the ice floe. The ice floe topology should be analyzed to determine the thickness, density, properties, mass and overall threat of the ice floe to drilling structures, ships, ports, and other structures that may be on or exposed to sea ice.

Rows 1 and 4 of Table 1 depict keel measurements taken within 12 hours on Apr. 30, 2009. Within that time frame, the max thickness and mean thickness of the keel has changed. For comparison, the thickness of the ice, as measured from the radar backscatter cross-section (RCS) profile of the corresponding SAR image, for Rows 1 and 4 are 299 and 76 m, respectively.

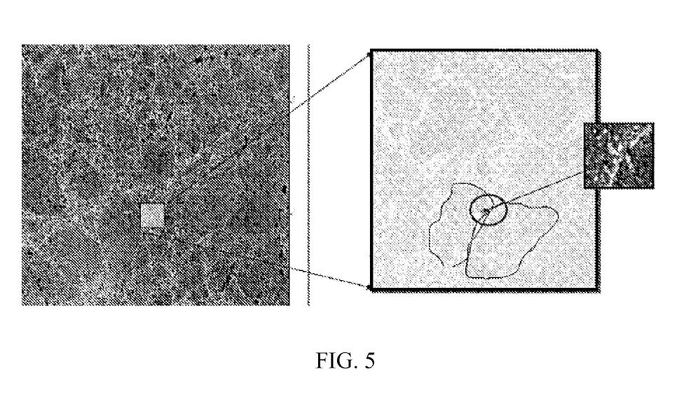

The ULS data can be synced with satellite data. FIG. 5 displays a TerraSAR-X High Resolution image, which corresponds to the ULS data in row 3 of Table 1 and includes an expanded view over the ULS location. In the expanded view, the outline of two ice floes that had collided and formed a ridge, as verified by an optical image obtained by SPOT. The keel thickness of the ridge, as measured by the ULS, is about 26 m. The circle in the expanded segment is the ULS's data collection area.

Creating ‘Movie’ of Images: Sequential pairs of optical images obtained by SPOT 5 for the entire 2008-2009 winter season can be stepped backward and forward simultaneously using known software.

Interpolation-type corrections are made to develop a best guest of how the previous image moved over the time frame between images. Basically, a Bayesian approach is taken to account for uncertainties in the uncollected images, allowing us to find the uniform movement implied by the distribution of probable images that could occur in between data acquisition. Given this uniform movement, a standard deconvolution algorithm can be utilized to map how the ice in the previous image moved before the second image was taken.

These corrections can be made for each sequential set of optical images. The whole winter period can be mapped, with the end result being a ‘movie’ that shows how the ice moved in as fine a time step as required through the entire season or as short an interval as the ULS data acquisition. The ULS in this particular example acquired data every 12 hours, thus a movie could be made with a 12 hour time step.

It should be noted that a thirty-six hour acquisition time frame is preferable when starting to track the ice movement. This can be adjusted up or downward as needed.

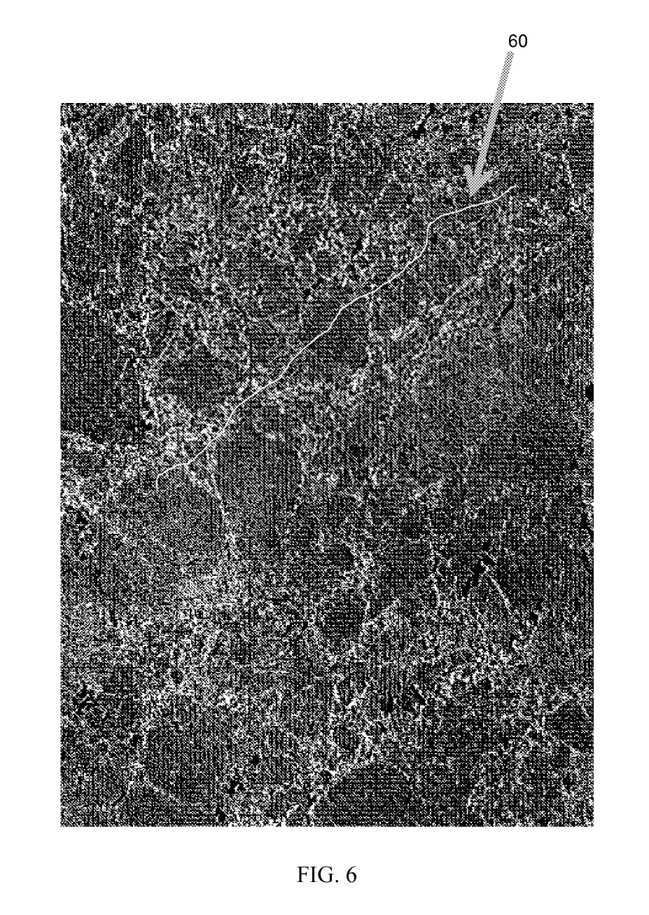

Correlating movie with satellite imagery: Once the movie is completed, an ice feature that moves over each ULS unit can be tracked through the movie. This track line for each ULS unit can then be overlaid onto the satellite images. FIG. 6 provides an estimate track line 60 for a SAR image.

The ice thickness, direction and velocity data from the ULS can then be used to assign ice thickness along the track line.

The ULS thickness measurements can be correlated with the SAR image to establish a relationship between measured keel depth and pixel shading for each pixel along the track line using data analysis.

The resulting relational expression can then be applied to future SAR images to determine an estimation of keel depth. Commercially available or custom software is equipped with a statistical toolbox capable of applying the relation expression, with an isostasy method approach, to the new SAR image. This will allow for a near-real time keel depth measurement using only satellite imagery in addition to the near-real time ice movement information generally provided by SAR.

The following references are incorporated by reference in their entirety.

U.S. Pat. No. 5,122,990

US20110291862

U.S. Pat. No. 4,697,254

U.S. Pat. No. 7,095,359

What is claimed is:

1) A method for near-real time estimation of ice keel thickness using Synthetic Aperture Radar (SAR), comprising:
a) measuring ice thickness, ice direction and ice velocity of sea ice over a plurality of ice profiling upward looking sonars (ULS) and current profiling ULS moored on the seafloor;
b) measuring, synchronously, ice movement of said sea ice using airborne optical and synthetic aperture radar imagery and/or optical imagery and/or stereo imagery;
c) combining ice thickness data from said ice profiling ULS with ice velocity data from said current profiling USL to form a profile representation of ice keel depth and movement for each moored ULS;
d) geographically stepping back a current image obtained from said airborne optical imagery to a previous image using said profile representation while simultaneously stepping forward from previous image to current image and comparing both the forward and back step to make an ice movement movie;
e) repeating step d) for all sequential airborne optical image pairs;
f) identifying an ice feature that appears in both said ice movement movie and said profile representation for a given said moored upward looking sonar;
g) calculating a track line for said ice feature from ice movement movie for said moored ice thickness measurement sonar;
h) overlaying said track line for a given ice feature on a synthetic aperture radar backscattering profile;
i) superimposing ice thickness measurements obtained from said moored ice profiling ULS over said track line and said synthetic aperture radar image;
j) correlating said ice thickness measurements along said track line with pixels from said synthetic aperture radar image along said track line resulting in a relational expression; and
k) applying said relational expression to future obtained synthetic aperture radar to estimate ice thickness for each pixel.

2) The method according to claim 1), wherein said synthetic aperture radar image is obtained in the X-band HV polarization mode.

3) The method according to claim 1), wherein said ice feature is a ridge.

4) A system for monitoring sea ice comprising:
a) a plurality of moored ice thickness measuring sonar for continuously measuring the thickness of overhead sea ice to make a thickness profile of said sea ice;
b) a plurality of moored current meters for continuously measuring the velocity and direction of said sea ice;
c) an airborne optical imaging device which observes said sea ice to obtain intermittent images, wherein the images are synchronized with said moored ice thickness measuring sonar and said moored current meter in order to make a track line profile of an ice feature drifting above said moored ice thickness measuring sonar and said moored current meter; and
d) an airborne SAR which observes said sea ice to obtain a SAR backscattering profile, wherein said SAR backscattering profile is synchronized with said track line and said ice thickness profile to correlated a rational expression between said ice thickness profile and said SAR backscattering profile for each pixel along said track line, and using said rational expression and the isostasy method to estimate thickness from future obtained SAR backscattering profiles.

5) The system of claim 4), wherein said moored ice thickness measuring sonar is an ice profiling sonar.

6) The system of claim 4), wherein said moored current meter is an acoustic Doppler current profiling sonar.

7) The system of claim 4), wherein said plurality of said moored ice thickness measuring sonar and said moored current meter are arranged concentrically around a drilling rig.

8) The system of claim 4), wherein said airborne optical imaging device takes high-resolution images.

9) The system of claim 8), wherein said airborne optical imaging device is configured to obtain stereo images.

10) The system of claim 4), wherein said airborne SAR is configured to obtain said SAR backscattering profile using 1 to 40 GHz range.

11) The system of claim 4), wherein said airborne SAR is configured to obtain said SAR backscattering profile using the X-band range.

12) The system of claim 4), further comprising a calculating device.

13) The system of claim 12), where said calculating device is capable of calculating said rational expression correlating said ice thickness profile and said SAR backscattering profile for each pixel along said track line, and applying said rational expression and isostasy method to said future obtained SAR backscattering profile.

14) A method of tracking sea ice thickness and movement, comprising
a) measuring a sea ice thickness using one or more ULS;
b) simultaneously recording stereo optic images and/or stereo SAR images of said sea ice;
c) using sequential image pairs, determining a movement vector of said sea ice;
d) overlaying said movement vector over one of said images;
e) correlating said ice thickness measurements along said movement vector with data points from said SARS or optical images along said movement vector resulting in a correlation between data points from said image and thickness; and
f) applying said correlation to future obtained SAR images to estimate ice thickness for each future data point.

15) A system for monitoring sea ice comprising:
a) a plurality of moored ice thickness measuring sonar for continuously measuring the thickness of overhead sea ice to make a thickness profile of said sea ice;
b) a plurality of moored current meters for continuously measuring the velocity and direction of said sea ice;
c) a plurality of cables connecting said moored ice thickness measuring sonar and said moored current meters to a monitoring center, wherein said cables are capable of transmitting information collected by said moored ice thickness measuring sonar and said moored current meters;
d) an airborne optical imaging device which observes said sea ice to obtain intermittent images, wherein the images are synchronized with said moored ice thickness measuring sonar and said moored current meter in order to make a track line profile of an ice feature drifting above said moored ice thickness measuring sonar and said moored current meter; and
e) an airborne SAR which observes said sea ice to obtain a SAR backscattering profile, wherein said SAR backscattering profile is synchronized with said track line to provide real time assessments of ice movement and thickness.

16) The system of claim 15), wherein said moored ice thickness measuring sonar is an ice profiling sonar.

17) The system of claim 15), wherein said moored current meter is an acoustic Doppler current profiling sonar.

18) The system of claim 15), wherein said cables are connected to a land-based monitoring center.

19) The system of claim 15), wherein said monitoring center is located on a drilling rig.

20) The system of claim 19), wherein said plurality of said moored ice thickness measuring sonar and said moored current meter are arranged concentrically around said drilling rig.

21) The system of claim 15), wherein said airborne optical imaging device takes high-resolution images.

22) The system of claim 15), wherein said airborne optical imaging device is configured to obtain stereo images.

23) The system of claim 15), wherein said airborne SAR is configured to obtain said SAR backscattering profile using 1 to 40 GHz range.

24) The system of claim 15), wherein said airborne SAR is configured to obtain said SAR backscattering profile using the X-band range.
